(19) United States
(12) Patent Application Publication
(10) Pub. No.: US 2025/0282089 A1
(43) Pub. Date: Sep. 11, 2025

(54) THERMOFORMING DEVICE

(71) Applicant: ASANO LABORATORIES CO., LTD., Miyoshi-shi, Aichi (JP)

(72) Inventors: Toshihiro TAKAI, Miyoshi-shi (JP); Yasushi OGUMA, Miyoshi-shi (JP)

(73) Assignee: ASANO LABORATORIES CO., LTD., Miyoshi-shi, Aichi (JP)

(21) Appl. No.: 18/860,302

(22) PCT Filed: Mar. 29, 2023
(86) PCT No.: PCT/JP2023/012892

§ 371 Date: Oct. 25, 2024

(30) Foreign Application Priority Data
May 23, 2022 (JP) 2022-083695

(51) Int. Cl. B29C 51/18; B29C 51/00; B29C 51/08; B29C 51/38; B29C 51/42; B29K 67/00; B29L 31/00

(52) U.S. Cl. CPC B29C 51/18; B29C 51/002; B29C 51/082; B29C 51/38; B29C 51/428; B29K 2067/003; B29L 2031/712

(57) ABSTRACT

This thermoforming device, which performs thermoforming of a continuously supplied resin sheet to simultaneously mold two or more rows of containers in the feed direction of the resin sheet, has: protruding linear portions of a leading clamp forming thin-walled portions in a direction perpendicular to the feed direction between the two rows of the containers; and protruding linear portions of an upper mold, wherein the protruding linear portions have a cooling means and do not raise the temperatures of the thin-walled portions to a crystallization temperature during heat set thermoforming.

### TECHNICAL FIELD

The invention relates to a thermoforming device for thermoforming a continuously fed resin sheet to simultaneously thermoform two or more rows of containers in a feed direction of the resin sheet.

### BACKGROUND ART

Conventionally, a thermoforming device is used for forming containers by continuously feeding a sheet of foamed resin (e.g., foamed PET or foamed PLA) (see Patent Document 1). Usual PET has a heat resistance temperature of about 60° C., which causes a problem that when the PET is heated in a heater such as an oven, it is deformed and fails to maintain its function as a container. C-PET is a mixture of PET and a crystal nucleating agent and, when heated above a crystallization temperature (130° C. for PET), the PET can be crystallized. The crystallized PET has a heat resistance of over 200° C. and therefore will not be deformed even when heated in a heater such as an oven. This type of thermoforming is referred to as heat-set thermoforming.

In a thermoforming device that thermoforms the continuously fed C-PET sheet to simultaneously form, for example, three rows of containers in the feed direction of the resin sheet, the C-PET sheet is heated to 190° C. during thermoforming, thereby crystallizing the containers by heat-set thermoforming.

The forming unit including three rows of containers in the thermoforming device is conveyed to a trimming device for a next process, where it is trimmed to the size of containers. The trimming device is faster than the thermoforming device and thus adopts a mode of punching out one row at a time instead of simultaneously punching out three rows. In this case, between the thermoforming device and the trimming device, the formed PET sheet bends or slacks to act as a buffer, adjusting the operating states of the thermoforming device and the trimming device.

### RELATED ART DOCUMENTS

### Patent Documents

Patent Document 1: Japanese utility model registration No. 3221505.

### SUMMARY OF INVENTION

### Problems to be Solved by the Invention

However, some problems are caused by slack of the PET sheet (the buffer) generated between the thermoforming device and the trimming device and bending or flexing of the PET sheet generated between the containers arranged in the feed direction (i.e., between the rows of containers) when the PET sheet enters the trimming device. Crystallized PET is increased in stiffness and decreased in toughness, resulting in easy cracking. Thus, if a scrap portion between rows of containers is greatly deformed by bending or flexing of the PET sheet between the rows of containers when entering the trimming device, cracks may occur at such a greatly deformed site. This would cause the problems that the containers with the cracks are hard to convey to a trimming step and, even if the containers could be conveyed, the distance between the container rows varies due to the generated cracks, causing deviation of the trimming position of the containers, making it impossible to punch out the containers accurately.

For solving the above-mentioned problems, the invention has a purpose to provide a thermoforming device configured to cause no cracks in a PET sheet even if the PET sheet crystallized by the thermoforming device is greatly deformed at a scrap portion between rows of containers just before a trimming device.

### Means of Solving the Problems

To achieve the above-mentioned purpose, one aspect of the present invention provides a thermoforming device that thermoforms a resin sheet, which is continuously fed, to simultaneously form two or more rows of containers in a feed direction of the resin sheet, wherein the thermoforming device comprises a thin-walled forming means provided between the two or more rows of containers and configured to form a thin-walled portion extending in a direction perpendicular to the feed direction, and the thin-walled forming means includes a cooling means to prevent the thin-walled portion from rising to a crystallization temperature during heat-set thermoforming. Herein, the heat-set thermoforming refers to thermoforming that crystallizes a container.

In the foregoing thermoforming device, preferably, the thin-walled portion is formed extending continuously over from one end face to the other end face of the resin sheet.

Another aspect of the invention provides a thermoforming device that thermoforms a resin sheet, which is continuously fed, to simultaneously form two or more rows of containers in a feed direction of the resin sheet, wherein the thermoforming device comprises a thin-walled forming means provided between the two or more rows of containers and configured to form a thin-walled portion extending in a direction perpendicular to the feed direction, and the thin-walled portion includes recesses formed in both opposing surfaces.

Further, another aspect of the invention provides a thermoforming device that thermoforms a resin sheet, which is continuously fed, to simultaneously form two or more rows of containers in a feed direction of the resin sheet, wherein the thermoforming device comprises a thin-walled forming means provided between the two or more rows of containers and configured to form a thin-walled portion extending in a direction perpendicular to the feed direction, and the thin-walled portion is formed at a leading end portion of a protruding ridge.

Still another aspect of the invention provides a thermoforming device that thermoforms a resin sheet, which is continuously fed, to simultaneously form two or more rows of containers in a feed direction of the resin sheet, wherein the thermoforming device comprises a thin-walled forming means provided between the two or more rows of containers and configured to form a thin-walled portion extending in a direction perpendicular to the feed direction, and the thin-walled forming means includes a leading clamp provided with a cooling means.

### Effects of the Invention

According to the thermoforming device configured as above, the thin-walled portion is formed between the container rows. Thus, by especially bending or flexing of the crystallized PET sheet caused between the container rows when the PET sheet enters the trimming device, the thin-walled portion is allowed to be greatly deformed at the scrap portion between the container rows, so that no cracks will occur. Since no cracks occur, it is not difficult to convey the PET sheet to the trimming step. Further, the distance between the rows of containers to be fed to the trimming device does not vary and the trimming position of the containers will not deviate, allowing the containers to be punched out accurately.

### BRIEF DESCRIPTION OF THE DRAWINGS

FIG. 1 is a diagram showing the configuration of an entire system incorporating a thermoforming device;

FIG. 2 is a cross-sectional view of a main part of the thermoforming device;

FIG. 3 is a cross-sectional view similar to FIG. 2, showing a state of a clamping step;

FIG. 4 is a cross-sectional view similar to FIG. 2, showing a state of a thermoforming step;

FIG. 5 is an enlarged view of a part A in FIG. 4;

FIG. 6 is a view in a second embodiment, corresponding to FIG. 4;

FIG. 7 is a view of a resin sheet in a formed state;

FIG. 8 is a perspective view showing the configuration of a leading clamp; and

FIG. 9 is an exploded perspective view showing the configuration of an upper mold, the leading clamp, and a lower mold.

### MODE FOR CARRYING OUT THE INVENTION

A detailed description of a first embodiment of a thermoforming device of the present invention will now be given referring to the accompanying drawings.

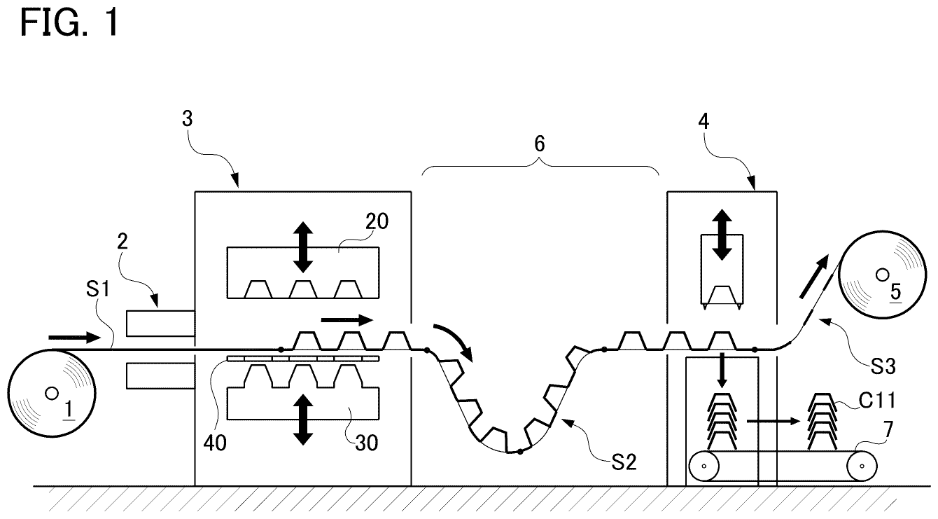

FIG. 1 shows the configuration of an entire system incorporating a thermoforming device 3. A resin sheet SI is fed from a feed roller 1. Upper and lower radiation heaters 2 are placed downstream of the feed roller 1 and above and below the resin sheet S1. A thermoforming device 3 for heat-set thermoforming is placed just downstream of the heaters 2. A trimming device 4 is placed at a certain distance from the thermoforming device 3, and a take-up roller 5 is placed downstream of the trimming device 4 to wind up a scrap sheet S3. Containers C11 trimmed in the trimming device 4 are carried out of the trimming device 4 by a transport conveyor 7 and then manually stacked.

The thermoforming device 3 is a thermoforming device that simultaneously thermoforms a total of nine containers C11: three containers C11 (three lines) in a width direction of the resin sheet S1 (the direction perpendicular to the feed direction) and three rows of containers C11 in the conveying direction. The trimming device 4 is a trimming device that punches out the containers C11, three in the width direction (three lines) and one row in the conveying direction at a time, that is, simultaneously punches out a total of three containers C11. The tact time of the trimming device 4 is faster more than three times than the tact time of the thermoforming device 3. Therefore, the trimming device 4 is controlled on and off and a buffer section 6 is placed between the thermoforming device 3 and the trimming device 4 to hold a formed resin sheet S2 in a slack state.

The resin sheet S1 is made of a foamed C-PET (PET containing a crystal nucleating agent that is an additive for promoting crystallization). The foaming magnification is 4 to 5 times and the thickness is 2 to 3 mm. The upper and lower radiation heaters 2 heat upper and lower surfaces of the resin sheet SI at the same time. The temperature of heating the resin sheet S1 differs depending on its material. The resin sheet S1 in the present embodiment is heated to reach about 100° C., which is higher than a crystallization temperature of PET, 71.1° C.

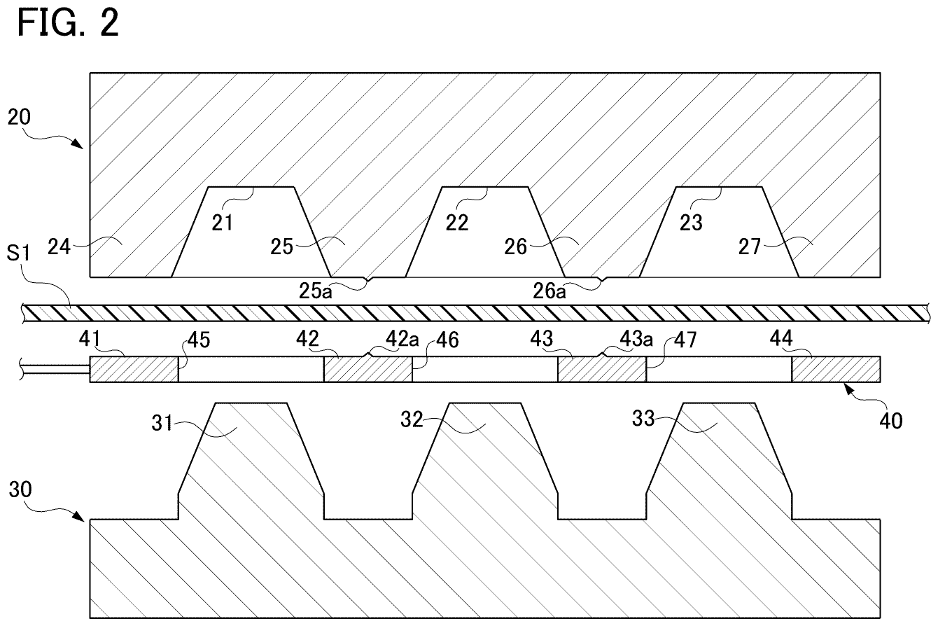

FIG. 2 is a cross-sectional view of a main part of the thermoforming device 3. The right-and-left direction in FIG. 2 is the conveying direction of the resin sheet S1. The resin sheet S1 is held between an upper mold 20, which is a female mold, and a lower mold 30, which is a male mold. A leading clamp 40 is placed between the resin sheet S1 and the lower mold 30.

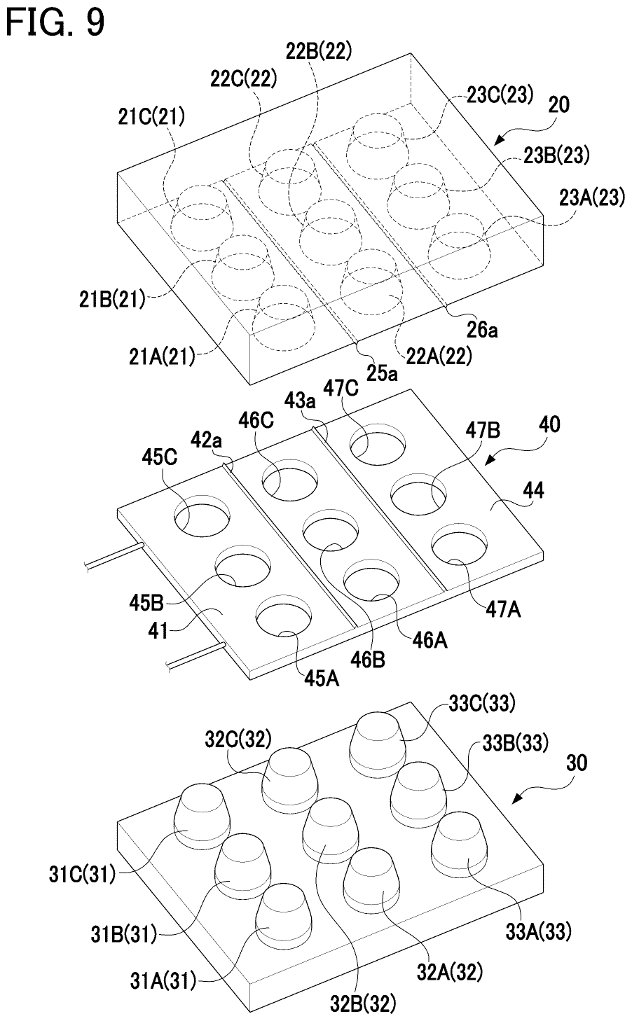

The upper mold 20 has female-mold recesses 21, 22, and 23 arranged in three rows in the conveying direction of the resin sheet S1. A total of nine female-mold recesses are formed: female-mold recesses 21A, 21B, and 21C (see FIG. 9) are arranged in the width direction of the resin sheet S1 (the depth direction in FIG. 2, which will be simply referred to as the width direction) as the row of the female-mold recesses 21, female-mold recesses 22A, 22B, and 22C (see FIG. 9) are arranged in the width direction (the depth direction in FIG. 2) as the row of the female-mold recesses 22, and female-mold recesses 23A, 23B, and 23C (see FIG. 9) are arranged in the width direction (the depth direction in FIG. 2) as the row of the female-mold recesses 23. Further, a clamp part 24 is formed in the lower surface (the surface facing the resin sheet S1) of the upper mold 20 on the left end side. A clamp part 25 is formed in the lower surface of the upper mold 20 between the female-mold recess 21 and the female-mold recess 22. A clamp part 26 is formed in the lower surface of the upper mold 20 between the female-mold recess 22 and the female-mold recess 23. A clamp part 27 is formed in the lower surface of the upper mold 20 on the right end side.

The lower mold 30 is formed with male-mold protrusions 31, 32, and 33 arranged in three rows in the conveying direction of the resin sheet S1. A total of nine male-mold protrusions are formed: male-mold protrusions 31A, 31B, and 31C (see FIG. 9) are arranged in the width direction (the depth direction in FIG. 2) as the row of the male-mold protrusions 31, male-mold protrusions 32A, 32B, and 32C (see FIG. 9) are arranged in the width direction (the depth direction in FIG. 2) as the row of the male-mold protrusions 32, and male-mold protrusions 33A, 33B, and 33C (see FIG. 9) are arranged in the width direction (the depth direction in FIG. 2) as the row of the male-mold protrusions 33.

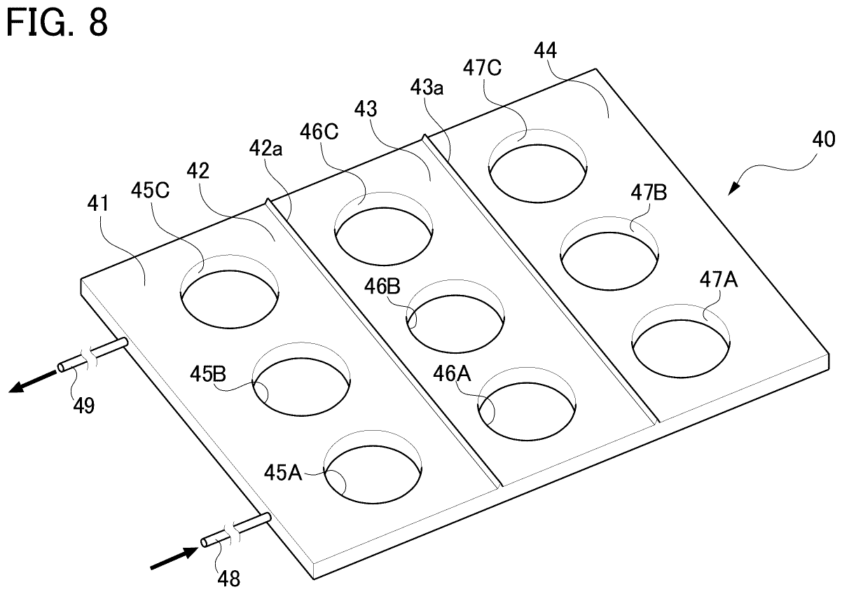

FIG. 8 is a perspective view showing the configuration of the leading clamp 40. FIG. 9 is an exploded perspective view showing the configuration of the upper mold 20, the leading clamp 40, and the lower mold 30. The leading clamp 40 is internally formed with a flow channel for water-cooling (not shown), and the leading clamp 40 is formed with a cooling water inlet 48 for inflow of cooling water into the water-cooling flow channel and a cooling water outlet 49 for outflow of cooling water from the water-cooling flow channel. The leading clamp 40 has openings 45A, 45B, and 45C penetrating through the leading clamp 40 at the positions corresponding to the male-mold protrusions 31A, 31B, and 31C of the lower mold 30, openings 46A, 46B, and 46C penetrating through the leading clamp 40 at the positions corresponding to the male-mold protrusions 32A, 32B, and 32C of the lower mold 30, and openings 47A, 47B, and 47C penetrating through the leading clamp 40 at the positions corresponding to the male-mold protrusions 33A, 33B, and 33C of the lower mold 30. In FIGS. 2 to 4, the openings 45A, 45B, 45C and the openings 46A, 46B, 46C are assigned reference signs 45 and 46 respectively for simplification.

The leading clamp 40 is formed with protruding linear portions 42a and 43a, which are a thin-walled forming means. The protruding linear portion 42a is formed at the center of an intermediate part 42 between the openings 45A, 45B, 45C and the openings 46A, 46B, 46C and extending linearly in the width direction. Further, the protruding linear portion 43a is formed at the center of an intermediate part 43 between the openings 46A, 46B, 46C and the openings 47A, 47B, 47C and extending linearly in the width direction.

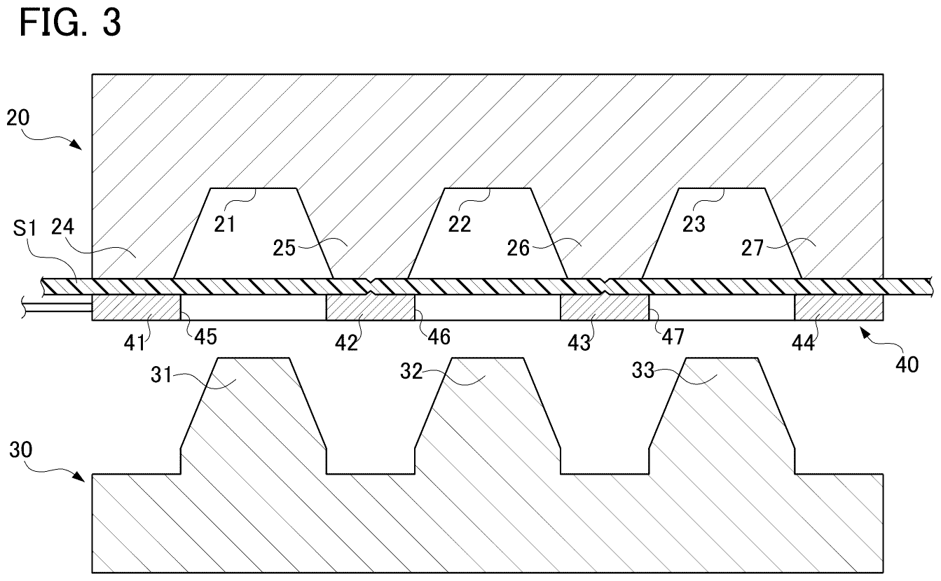

At the center of each of the clamp part 25 and the clamp part 26 of the upper mold 20, protruding linear portions 25a and 26a are respectively formed extending linearly in the width direction. As shown in FIGS. 2 to 3, the protruding linear portion 42a is located at a position facing the protruding linear portion 25a, and the protruding linear portion 43a is located at a position facing the protruding linear portion 26a. In the present embodiment, a left end part 41 of the leading clamp 40 in the figure (an end part on the rear side in the conveying direction) and a left end part 44 (an end part on the front side in the conveying direction) are not provided with the protruding linear portions, but may be provided with the protruding linear portions.

Next, the operations of the thermoforming device 3 will be described referring to the drawings. FIG. 2 shows a state before thermoforming is performed. The resin sheet S1 is heated in advance by the heaters 2 to about 100° C., which is a glass-transition temperature.

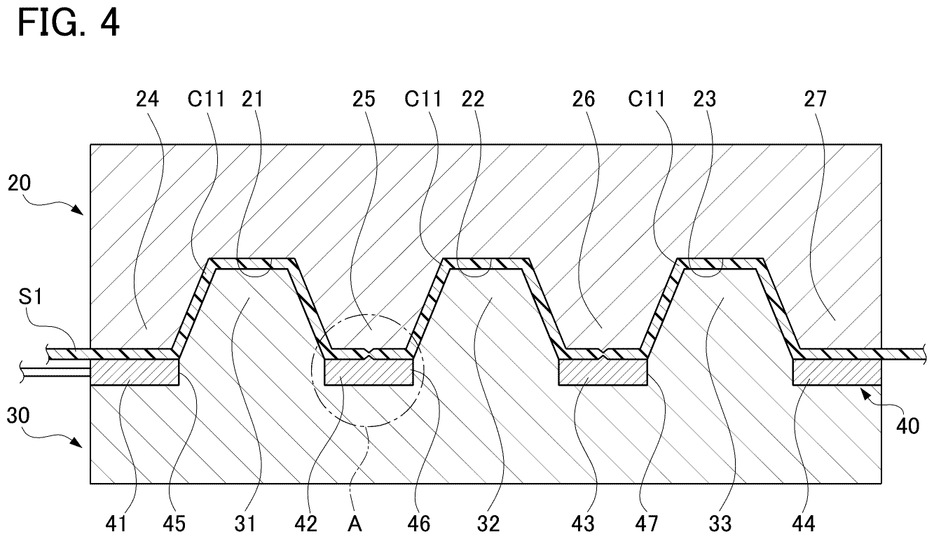

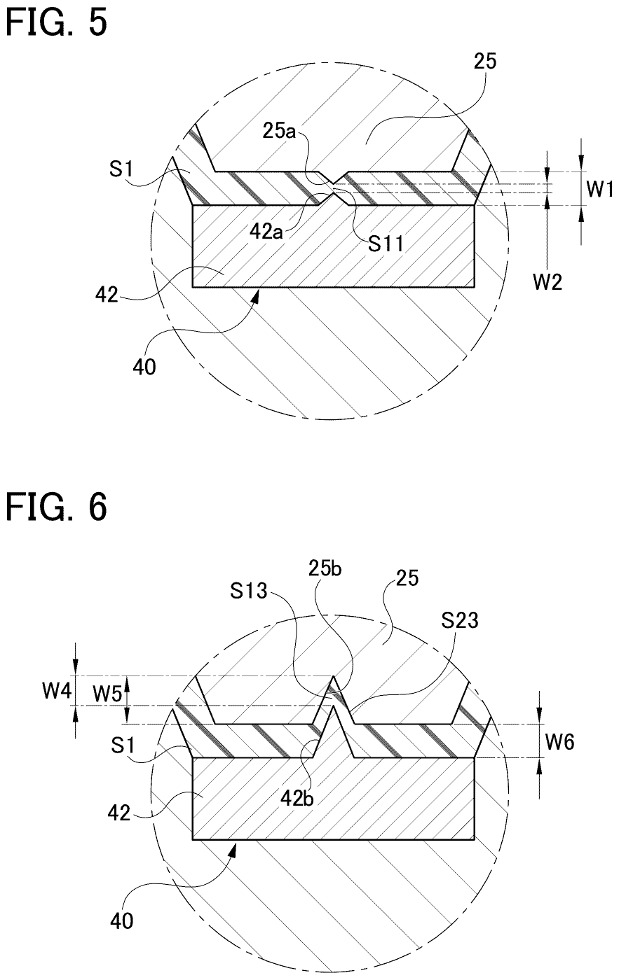

The subsequent clamping step is shown in FIG. 3, and the thermoforming step following the clamping step is shown in FIG. 4. Further, FIG. 5 shows an enlarged view of a part A in FIG. 4. When the upper mold 20 is moved down and the leading clamp 40 is lifted up with respect to the heated resin sheet S1, a left end part (the clamp part 24) of the upper mold 20 and the left end part 41 of the leading clamp 40 sandwich and press the resin sheet S1 therebetween so that the thickness of the resin sheet S1 is for example 1.5 mm. Similarly, a right end part (the clamp part 27) of the upper mold 20 and the left end part 44 of the leading clamp 40 sandwich and press the resin sheet S1 therebetween so that the thickness of the resin sheet S1 is for example 1.5 mm.

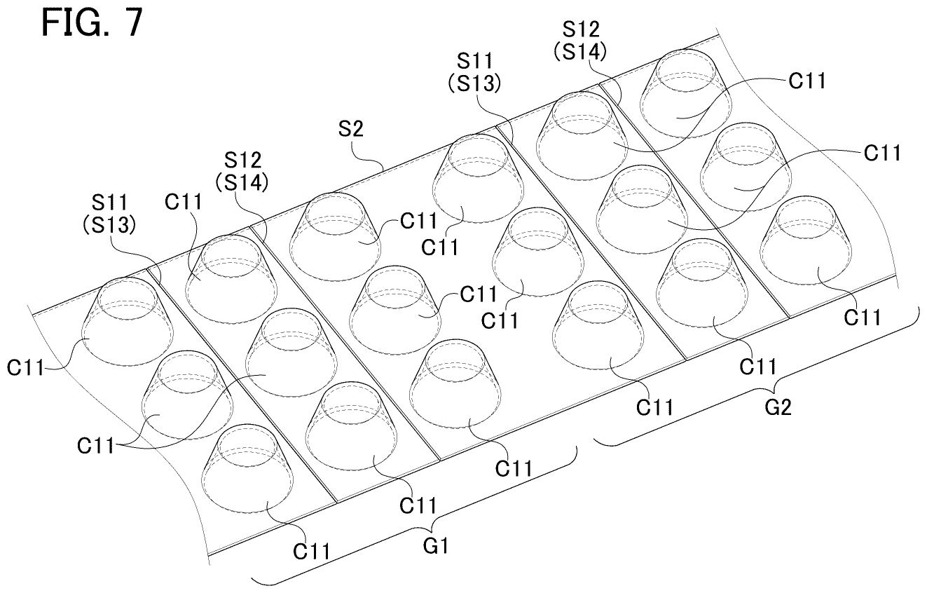

The clamp part 25 of the upper mold 20 and the intermediate part 42 of the leading clamp 40 sandwich and press the resin sheet S1 so that the thickness W1 of the resin sheet S1 is for example 1.5 mm, as shown in FIG. 5. Simultaneously, a portion (part of the resin sheet) sandwiched between the protruding linear portion 42a of the intermediate part 42 and the protruding linear portion 25a of the clamp part 25 is formed with a thin-walled portion S11 with a thickness W2 of 0.7 mm, for example. Similarly, a portion (part of the resin sheet) sandwiched between the protruding linear portion 43a of the intermediate part 43 and the protruding linear portion 26a of the clamp part 26 is formed with a thin-walled portion S12 (see FIG. 7) with a thickness W2 of 0.7 mm, for example. The positions of the thin-walled portions S11 and S12 are shown in FIG. 7.

Next, the thermoforming step will be described. The lower mold 30 is moved up with respect to the resin sheet S1 in a clamped state between the upper mold 20 and the leading clamp 40, subjecting nine containers C11 to heat-set thermoforming at the same time. Specifically, while the state shown in FIG. 4 is kept, the temperatures of the upper mold 20 and the lower mold 30 are raised to 190° C. and kept for 10 seconds. By this 10-second keeping at 190° C., the portions of the resin sheet S1 corresponding to the nine containers C11 formed between the female-mold recesses 21A, 21B, 21C, 22A, 22B, 22C, 23A, 23B, 23C of the upper mold 20 and the male-mold protrusions 31A, 31B, 31C, 32A, 32B, 32C, 33A, 33B, 33C are heated to 190° C. and crystallized.

Herein, since the leading clamp 40 is cooled with cooling water of 20° C., even when the upper mold 20 is heated to 190° C., the resin sheet portion sandwiched between the protruding linear portion 42a of the intermediate part 42 and the protruding linear portion 25a of the clamp part 25 and near the thin-walled portion S11, S12 sandwiched between the protruding linear portion 43a of the intermediate part 43 and the protruding linear portion 26a of the clamp part 26 are only heated to the vicinity of 30 to 50° C. Thus, they will not crystallize and will be maintained with low stiffness.

Next, the trimming step of punching out the containers C11 by one row at a time, and the buffer step in the buffer section 6 between the thermoforming device 3 and the trimming device 4 are described. FIG. 7 shows the resin sheet S2 after the forming step. The thermoforming device 3 forms a total of nine containers C11, arranged in three rows by three lines, in one thermoforming process. Therefore, the group G1 and the group G2 in FIG. 7 indicate the groups of containers obtained by two consecutive thermoforming processes.

A portion between the group G1 and the group G2, each including nine formed containers C11, does not contact with the upper mold 20 and the lower mold 30 and thus is not heated to 190° C. by the thermoforming device 3. This portion therefore does not crystallize and is flexible due to its low stiffness, and will be deformed without difficulty when the resin sheet S2 is caused to slack or sag in the buffer step, and has no risk of cracking.

In the trimming device 4, the containers C11 are punched out by one row at a time. When going from the buffer section 6 into the trimming device 4, the resin sheet S2 may greatly bend or flex between the container rows. Specifically, for example, a large bend or deflection may occur between the row of containers C11 formed by the female-mold recesses 23 and the male-mold protrusions 33 in FIG. 4 and the row of containers C11 formed by the female-mold recesses 22 and the male-mold protrusions 32. Even in such a case, the thin-walled portion S11, S12 is easily deformed because it is thin-walled and additionally not crystallized, and has no risk of cracking.

The thermoforming device 3 in the present embodiment provides the following operations and advantageous effects.

(1) The thermoforming device 3 for thermoforming the resin sheet S1, which is continuously fed, to simultaneously form the containers C11 in two or more rows in the feed direction includes the protruding linear portions 42a, 43a of the leading clamp 40 and the protruding linear portions 25a, 26a of the upper mold 20 provided between the two or more rows of the containers C11 and configured to form the thin-walled portions S11, S12 extending in the direction perpendicular to the feed direction. Since each thin-walled portion S11, S12 is formed between the rows of the containers C11, the thin-walled portion S11, S12 is allowed to be greatly deformed at the scrap portion between the container rows by especially bending or flexing of the crystallized PET sheet caused between the container rows when the PET sheet enters the trimming device 4, so that no cracks will occur. Since no cracks occur, it is not difficult to convey the PET sheet to the trimming step. Further, the distance between the rows of the containers C11 remains unchanged and thus the trimming positions of the containers C11 will not deviate, allowing accurate punching-out of the containers C11.

(2) In the thermoforming device 3 described in (1), the protruding linear portions 42a, 43a of the leading clamp 40 each have a cooling means (e.g., the cooling water inlet 48 and the cooling water outlet 49) to suppress the thin-walled portions S11, S12 from rising to a crystallization temperature during heat-set thermoforming. The portions for containers C11 are crystallized to enhance stiffness, but the thin-walled portions S11, S12 are not crystallized and have low stiffness, and thus can be easily deformed. Consequently, no cracks will occur in a deformed portion.

(3) In the thermoforming device 3 described in (1) or (2), the thin-walled portions S11, S12 are formed extending continuously over from one end face to the other end face of the resin sheet S2. The crystallized resin sheet S2 is deformed at the thin-walled portions S11, S12 over the entire length in the width direction and thus can be deformed reliably and uniformly at each thin-walled portion.

(4) In the thermoforming device 3 described in any one of (1) to (3), the thin-walled portions S11, S12 each include the recesses formed in both opposing surfaces. Accordingly, when the resin sheet S2 is deformed at a recessed portion that is the thin-walled portion S11, S12, the surfaces of the resin sheet S2 on both side do not interfere with deformation of the resin sheet S2. This allows the thin-walled portion to be deformed stably and uniformly.

(5) In the thermoforming device 3 described in any one of (1) to (4), the protruding linear portions 42a, 43a of the leading clamp 40 each include the leading clamp 40 provided with the cooling mans (e.g., the cooling water inlet 48, the cooling water outlet 49). Prior to thermoforming, the leading clamp 40 and the upper mold 20 sandwich therebetween the scrap portion located between the containers C11, cooling the resin sheet S1 in contact with the leading clamp 40. Thus, the scrap portion between the containers C11 does not reach the crystallization temperature and that portion is not crystallized, and can remain low in stiffness.

Next, a second embodiment of the invention will be described. The second embodiment is substantially identical in structure and operation to the first embodiment, and hence only differences will be described and the same description is omitted.

FIG. 6 shows the shape of the thin-walled portion S11, S12 and the

protruding linear portion in the second embodiment. The clamp part 25 of the upper mold 20 is provided with, a recessed, not protruding, linear portion 25b. The recess depth W5 of the recessed linear portion 25b is for example W5=4 to 5 mm. Further, the intermediate part 42 of the leading clamp 40 is provided with a protruding linear portion 42b higher than the protruding linear portion 42a of the first embodiment.

The flat portions of the clamp part 25 and the intermediate part 42 form the resin sheet S1 with a thickness W6=1.5 mm, for example. The protruding linear portion 42b comes into the recessed linear portion 25b to form a protruding ridge S23 in the resin sheet S1. Simultaneously, a thin-walled portion S13 is formed at a leading end portion of the protruding ridge S23. The thin-walled portion S13 has a thickness W=1 mm, for example. The same applies to the clamp part 26 and the intermediate part 43; a protruding ridge is formed and a thin-walled portion S14 (see FIG. 7) is formed at its a leading end portion.

According to the thermoforming device 3 in the second embodiment, each thin-walled portions S13, S14 is formed at a leading end portion of the protruding ridge S23, S24. The protruding ridge S23, S24 is easily widened by deformation of the thin-walled portion S13, S14, making it easy to uniformly deform both slant surfaces of the protruding ridge. Thus, the end angle of the leading end portion of the protruding ridge S23 allows the thin-walled portion including the slant surfaces to be deformed stably and uniformly.

The above description is given to the thermoforming device 100, but the invention is not limited thereto and may be changed variously without departing from the scope of the invention. For example, the first embodiment exemplifies that the thickness of the resin sheet S1 is W1=1.5 mm, and the thickness of the thin-walled portions S11, S12 is W2=0.7 mm, and the second embodiment exemplifies that the thickness of the resin sheet S1 is W5=1.5 mm and the thickness of the thin-walled portions S13, S14 is W2=1.0 mm. These ratios may be arbitrarily changed according to the types of materials. In the present embodiments, the thin-walled portions S11, S12 are each formed extending continuously in the width direction, but may be formed extending intermittently in the width direction of the resin sheet.

### Reference Signs List

2 Heater
3 Thermoforming device
4 Trimming device
6 Buffer section
20 Upper mold
25, 26 Clamp part
25a, 26a Protruding linear portion
25b, 26b Recessed linear portion
30 Lower mold
40 Leading clamp
42, 43 Intermediate part
42a, 43a Protruding linear portion
42b, 43b Protruding linear portion
S1 Resin sheet before thermoforming
S2 Resin sheet after thermoforming
S3 Scrap sheet after trimming (scrap)
S11, S12 Thin-wall portion
S13, S14 Thin-wall portion
S23 Protruding ridge

1. A thermoforming device that thermoforms a resin sheet, which is continuously fed, to simultaneously form two or more rows of containers in a feed direction of the resin sheet,
wherein the thermoforming device comprises a thin-walled forming means provided between the two or more rows of containers and configured to form a thin-walled portion extending in a direction perpendicular to the feed direction, and
the thin-walled forming means includes a cooling means to prevent the thin-walled portion from rising to a crystallization temperature during heat-set thermoforming.

2. In the thermoforming device according to claim 1, wherein the thin-walled portion is formed extending continuously over from one end face to the other end face of the resin sheet.

3. A thermoforming device that thermoforms a resin sheet, which is continuously fed, to simultaneously form two or more rows of containers in a feed direction of the resin sheet,
wherein the thermoforming device comprises a thin-walled forming means provided between the two or more rows of containers and configured to form a thin-walled portion extending in a direction perpendicular to the feed direction, and
the thin-walled portion includes recesses formed in both opposing surfaces.

4. A thermoforming device that thermoforms a resin sheet, which is continuously fed, to simultaneously form two or more rows of containers in a feed direction of the resin sheet,
wherein the thermoforming device comprises a thin-walled forming means provided between the two or more rows of containers and configured to form a thin-walled portion extending in a direction perpendicular to the feed direction, and
the thin-walled portion is formed at a leading end portion of a protruding ridge.

5. A thermoforming device that thermoforms a resin sheet, which is continuously fed, to simultaneously form two or more rows of containers in a feed direction of the resin sheet,
wherein the thermoforming device comprises a thin-walled forming means provided between the two or more rows of containers and configured to form a thin-walled portion extending in a direction perpendicular to the feed direction, and
the thin-walled forming means includes a leading clamp provided with a cooling means.
